(19) United States
(12) Patent Application Publication
(10) Pub. No.: US 2013/0199632 A1
(43) Pub. Date: Aug. 8, 2013

(54) BALANCING VALVE IN FAUCET

(71) Applicant: Chung-Hsing Law, Shanghai (CN)

(72) Inventor: Chung-Hsing Law, Shanghai (CN)

(73) Assignee: SHANGHAI GEAR PLASTIC CO., LTD., Shanghai (CN)

(21) Appl. No.: 13/367,699

(22) Filed: Feb. 7, 2012

(51) Int. Cl. F16K 17/00

(52) U.S. Cl. 137/511

(57) ABSTRACT

A balancing faucet in a faucet includes a valve shell, a connecting cover, a rotating shaft, a ceramic valve set, a valve base and a balancing valve set. The ceramic valve set has a first valve piece and a second valve piece attaching to each other, and a collecting trough is formed at the direction from the first valve piece to the second valve piece, and the second valve piece has a hot water inlet, a cold water inlet and a water outlet. The valve base has a receiving chamber to receive the balancing valve set formed by two symmetric engaging shells to provide a valve-shaft hole for a valve cover. The valve cover has two water-guiding slots and a moving valve that has two flow restricting openings and a stopping wall to automatically adjust the flow of cold and hot water to further maintain the water temperature.

### FIELD OF THE INVENTION

The present invention relates to a balancing valve in a faucet, and more specifically to a balancing valve in a faucet that can automatically adjust water flow using the change of water pressure.

### BACKGROUND OF THE INVENTION

A conventional faucet usually has a control valve inside, and the control valve is used for water outputting. However, the design of an outer shell of the conventional faucet only has a space to receive the control valve and there is no additional space for a balancing valve. So, when a user wants to install the balancing valve to maintain the water temperature, the entire outer shell of the faucet has to be replaced, which will cause inconvenience during assembly/disassembly process and waste of the materials. If there is no balancing valve and the water flow is divided when in use, the water pressure of the cold and hot water may be imbalanced to generate unstable water flow, and may cause the sudden temperature change of the water. More seriously, the unexpected hot water may burn the user. Therefore, how to use the balancing vale to automatically adjust the water flow to maintain the water temperature when the water pressure changes, and how to install the control valve with the balancing valve in the outer shell of the faucet are two technical points that the present invention wants to solve. In addition, regarding the effect of anti-scald, when a conventional handle of the faucet is used for changing water temperature, the cold water is on one end and the hot water is on the other end, and the cold/hot water mixing status is between the two ends. In this setting, it is disadvantageous that the user may mistakenly rotate the handle to the hot water end to release the entire hot water, and the user may be burned by the hot water.

### SUMMARY OF THE INVENTION

In order to solve and overcome the problems stated above, the present invention provides a balancing valve in a faucet, which includes a valve shell, a connecting cover, a rotating shaft, a ceramic valve set, a valve base and a balancing valve set. The valve shell has a through receiving space, and a bottom end is formed at one end of the receiving space of the valve shell, and the other end has a top end. The connecting cover is disposed into the receiving space from the bottom end and against the top end of the valve shell. The connecting cover has a through shaft hole that is far away from the top end of the valve shell to form a engaging section, and a plurality of connecting blocks are protrudingly formed at an outer surface of the engaging section of the connecting cover. The rotating shaft has a rotating portion and an engaging portion. The rotating shaft is disposed at the shaft hole of the connecting cover, and the engaging portion of the rotating shaft is fixed at the engaging section of the connecting cover, and the rotating portion is extending and protruding through the top end of the valve shell. The ceramic valve set include a first valve piece and a second valve piece, and one end of the first valve piece is against the connecting cover, and connects to the connecting blocks to form a plurality of recessed slots. The connecting block is disposed into the recessed slot to connect and drive the connecting cover and the first valve piece. A collecting trough is formed at the direction from the first valve piece towards the second valve piece, and the second valve piece is through to form a hot water inlet, a cold water inlet and a water outlet, and a plurality of notches are recessedly formed at an outer edge of the second valve piece. The valve base is fixed at the bottom end of the valve shell and against the second valve piece. The valve base forms a cold water hole, a hot water hole and a water outlet hole is at the same position corresponding to the second valve piece. A plurality of restricting blocks are formed at an outer edge of the valve base, and the second valve piece is fixed through the engagement of the restricting block and the notch. Also, the valve base has a receiving chamber formed between the cold water hole and the hot water hole. The balancing valve set is disposed in the receiving chamber of the valve base, and the balancing valve set has two engaging shells, a valve cover and a moving valve. The engaging shells are symmetric to form a valve-shaft hole for the valve cover, and an inlet end and an outlet end are connected and located at both ends of the valve-shaft hole. The outlet end of the engaging shells is used to connect the cold water hole or the hot water hole. The valve cover is tubular and two water-guiding slots are formed at the tube wall corresponding to the inlet end of the engaging shells. The moving valve is slidingly formed inside the valve cover, and the moving valve has two flow restricting openings corresponding to the water-guiding slots of the valve cover, and a stopping wall is formed between two flow restricting openings.

It is a main objective of the present invention that when the imbalance of the cold and hot water pressure results, the moving valve of the balancing valve set is slidingly disposed in the valve cover to push the stopping wall of the moving valve by the cold and hot water pressure, and the moving valve slightly slides towards the end with smaller water pressure. So, the flow restricting openings of the moving valve block different amount of water from the water-guiding slots to adjust the amount of water from therefrom to achieve the goal of automatically adjusting the flow of the cold and hot water by the change of water pressure. It can further achieve the goal of maintaining water output temperature to increase the safety when in use.

It is another objective of the present invention that the balancing valve set is disposed at the receiving chamber of the valve base from outside, so when a user wants to clean or replace it, the balancing valve set can be taken out directly from the valve base without disassembling the valve shell and valve base to further achieve the goal of easy cleaning and replacement. Also, the size is reduced since the balancing valve set is disposed in the receiving chamber of the valve base, so that it can be used for conventional faucets.

It is a further objective of the present invention that when the connecting cover rotates axially, the extending portion is blocked and restricted by the restricting portion of the valve shell to control a rotating angle of the connecting cover. Furthermore, the collecting trough of the first vale piece has a circular portion that extends to form a first fan-shaped portion and a second fan-shaped portion, and a mixing trough is formed and connected with the water outlet closely attaching to the first valve piece. The mixing trough extends toward a location between the hot water inlet and the cold water inlet, and when the first fan-shaped portion and second fan-shaped portion are aligned with the mixing trough, the ceramic valve set shuts off and no water is outputted. When the first valve piece starts to rotate, the first fan-shaped portion of the collecting trough overlaps the cold water inlet of the second valve piece, and if the first valve piece further rotates, the second fan-shaped portion overlaps the hot water inlet of the second valve piece. So, whenever the faucet is in use, the cold water will always come out first and then the warm or hot water to avoid the accident of burning.

### BRIEF DESCRIPTION OF THE DRAWINGS

FIG. 1 illustrates a three-dimensional view in the present invention.

FIG. 2 illustrates a three-dimensional exploded view from an upper view angle in the present invention.

FIG. 3 illustrates a three-dimensional exploded view from a lower view angle in the present invention.

FIG. 4 illustrates a plan view of the bottom end in the present invention.

FIG. 5 illustrates a schematic view of FIG. 4 along section A-A in the present invention.

FIG. 6 illustrates a schematic view of FIG. 4 along section B-B in the present invention.

FIG. 7 illustrates a schematic view of FIG. 4 along section A-A regarding the balancing valve set in the present invention.

FIG. 8 illustrates schematic view of the restricting status of the valve shell and connecting cover in the present invention.

FIG. 9 illustrates a three-dimensional schematic view of the ceramic valve set in the present invention.

FIG. 10 illustrates a schematic view of the ceramic valve set when shut off in the present invention.

FIG. 11 illustrates a schematic view of the ceramic valve set when the cold water is allowed to release in the present invention.

FIG. 12 illustrates a schematic view of the ceramic valve set when the hot water is allowed to release in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

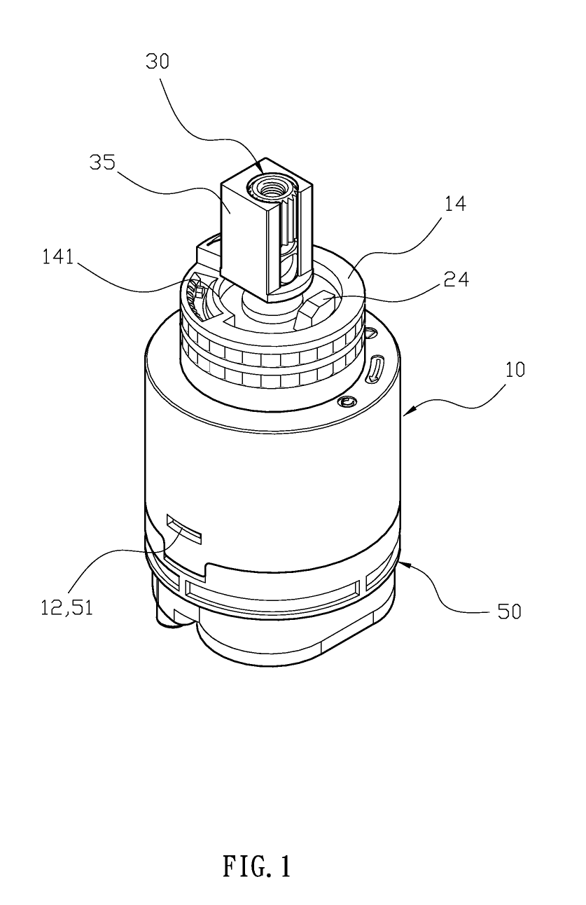

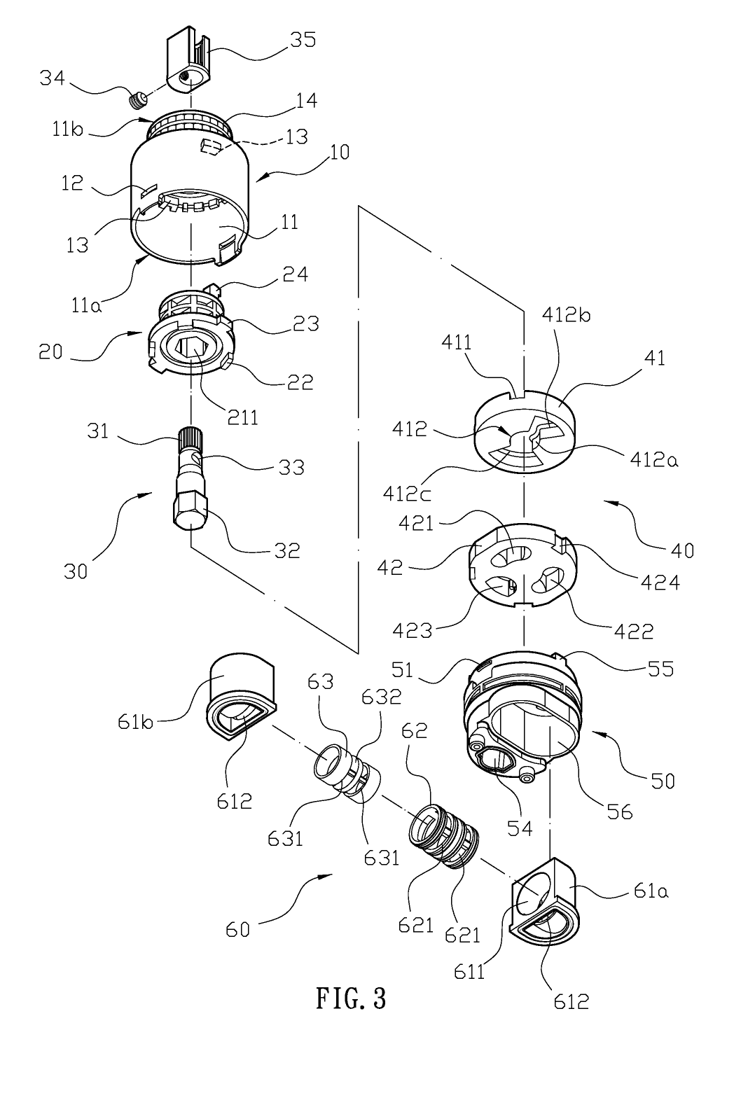

Referring to FIGS. 1 to 3, a balancing valve in a faucet includes a valve shell (10), a connecting cover (20), a rotating shaft (30), a ceramic valve set (40), a valve base (50) and a balancing valve set (60). The valve shell (10) has a through receiving space (11), and a bottom end (11a) is formed at one end of the receiving space (11) of the valve shell (10), and the other end has a top end (11b), and a plurality of engaging holes (12) are formed at the bottom end (11a) of the valve shell (10). The connecting cover (20) is disposed into the receiving space (11) from the bottom end (11a) and against the top end (11b) of the valve shell (10). The connecting cover (20) has a through shaft hole (21) that is far away from the top end (11b) of the valve shell (10) to form a engaging section (211), and a plurality of connecting blocks (22) are protrudingly formed at an outer surface of the engaging section (211) of the connecting cover (20). The rotating shaft (30) has a rotating portion (31) and an engaging portion (32). The rotating shaft (30) is disposed at the shaft hole (21) of the connecting cover (20), and the engaging portion (32) of the rotating shaft (30) is fixed at the engaging section (211) of the connecting cover (20), and the rotating portion (31) is extending and protruding through the top end (11b) of the valve shell (10). A screw hole (33) is formed at a top portion of the valve shell (10) that the rotating shaft (30) protrudes through, and the screw hole (33) provides a bolt (34) to lock a corresponding unit (35), so that the rotating shaft (30) can choose a knob that is used for either a circular hole or a square hole through the corresponding unit (35) (now shown). The ceramic valve set (40) include a first valve piece (41) and a second valve piece (42), and one end of the first valve piece (41) is against the connecting cover (20), and connects to the connecting blocks to form a plurality of recessed slots (411). The connecting block (22) is disposed into the recessed slot (411) to connect and drive the connecting cover (20) and the first valve piece (41). A collecting trough (412) is formed at the direction from the first valve piece (41) towards the second valve piece (42), and the second valve piece (42) is through to form a hot water inlet (421), a cold water inlet (422) and a water outlet (423), and a plurality of notches (424) are recessedly formed at an outer edge of the second valve piece (42). The valve base (50) has a plurality of engaging blocks (51) corresponding to the engaging holes (12) of the valve shell (10), and the valve shell (10) and the valve base (50) are connected through the engagement of the engaging holes (12) and the engaging blocks (51). The valve base (50) forms a cold water hole (52), a hot water hole (53) and a water outlet hole (54) is at the same position corresponding to the second valve piece (42). A plurality of restricting blocks (55) are formed at an outer edge of the valve base (50), and the second valve piece (42) is fixed through the engagement of the restricting block (55) and the notch (424). Also, the valve base (50) has a receiving chamber (56) formed between the cold water hole (52) and the hot water hole (53). A balancing valve set (60) is disposed in the receiving chamber (56) of the valve base (50), and the balancing valve set (60) has two engaging shells (61a) (61b), a valve cover (62) and a moving valve (63). The engaging shells (61a)(61b) are symmetric to form a valve-shaft hole (611) for the valve cover (62), and an inlet end (612) and an outlet end (613) are connected and located at both ends of the valve-shaft hole (611). The outlet end (613) of the engaging shells (61a)(61b) is used to connect the cold water hole (52) or the hot water hole (53). The valve cover (62) is tubular and two water-guiding slots (621) are formed at the tube wall corresponding to the inlet end (612) of the engaging shells (61a)(61b). The moving valve (63) is slidingly formed inside the valve cover (62), and the moving valve (63) has two flow restricting openings (631) corresponding to the water-guiding slots (621) of the valve cover (62), and a stopping wall (632) is formed between two flow restricting openings (631). Through the structure mentioned above, the hot and cold water flows separately from the balancing valve set (60) to the cold water hole (52) and the hot water hole (53) of the valve base (50), and the hot and cold water is mixed through the selection of the valve position of the ceramic valve set (40), and finally the water is outputted from the water outlet hole (54) of the valve base (50). When the cold and hot water pressure is not balanced, the moving valve (63) of the balancing valve set (60) is slidingly formed in the valve cover (62), and the stopping wall (632) of the moving valve (63) is pushed by the cold and hot water pressure, so that the flow restricting opening (631) of the moving valve (63) is aligned with the guiding slot (621) of the valve cover (62) to achieve the goal of automatically adjusting the cold and hot water flow through the change of water pressure to further maintain constant temperature of the outputting water.

Referring again to FIGS. 1 to 3 for the structure of the present invention, the connecting cover (20) is disposed onto the rotating shaft (30) through the shaft hole (21), and the engaging portion (32) of the rotating shaft (30) is fixed at the engaging section (211) of the connecting cover (20). Furthermore, the connecting cover (20) and the rotating shaft (30) are disposed into the receiving space (11) from the bottom end (11a) of the valve shell (10), so that the rotating portion (31) of the rotating shaft (30) protrudes through the top end (11b) of the valve shell (10). The ceramic valve set (40) is in contact with a mixing trough (425) through the first (41) and second (42) valve pieces, and the first valve piece (41) is disposed into the receiving space (11) of the valve shell (10), so that the recessed slot (411) of the first valve piece (41) is connected with the connecting block (22) of the connecting cover (20) to form a connecting-driving status between the first valve piece (41) and the connecting cover (20). The valve base (50) engages with the valve shell (10) through the engagement of the engaging block (51) and the engaging hole (12), meaning that the valve base (50) engages at the bottom end (11a) of the valve shell (10). Furthermore, the cold water hole (52), hot water hole (53) and the water outlet hole (54) are formed corresponding to the hot water inlet (421), cold water inlet (422) and water outlet (423). The restricting block (55) of the valve base (50) extends and protrudes to the notch (424) of the second valve piece (42) to form a restricting positioning, so that the second valve piece (42) is stopped and fixed by the valve base (50). The moving valve (63) of the balancing valve set (60) is disposed into the valve cover (62), and the valve-shaft hole (611) of the engaging shells (61a)(61b) is disposed outside the valve cover (62), and finally the balancing valve set (60) is disposed into the receiving chamber (56) of the valve base (50), so that the outlet end (613) of the engaging shells (61a)(61b) are connected with the cold water hole (52) and hot water hole (53) of the valve base (50) to complete the assembly process. The balancing valve set (60) is disposed at the receiving chamber (56) of the valve base (50) from outside, so when a user wants to clean or replace it, the balancing valve set (60) can be taken out directly from the valve base (50) without disassembling the valve shell (10) and valve base (50) to further achieve the goal of easy cleaning and replacement. Also, the size is reduced since the balancing valve set (60) is disposed in the receiving chamber (56) of the valve base (50), so that it can be used for conventional faucets.

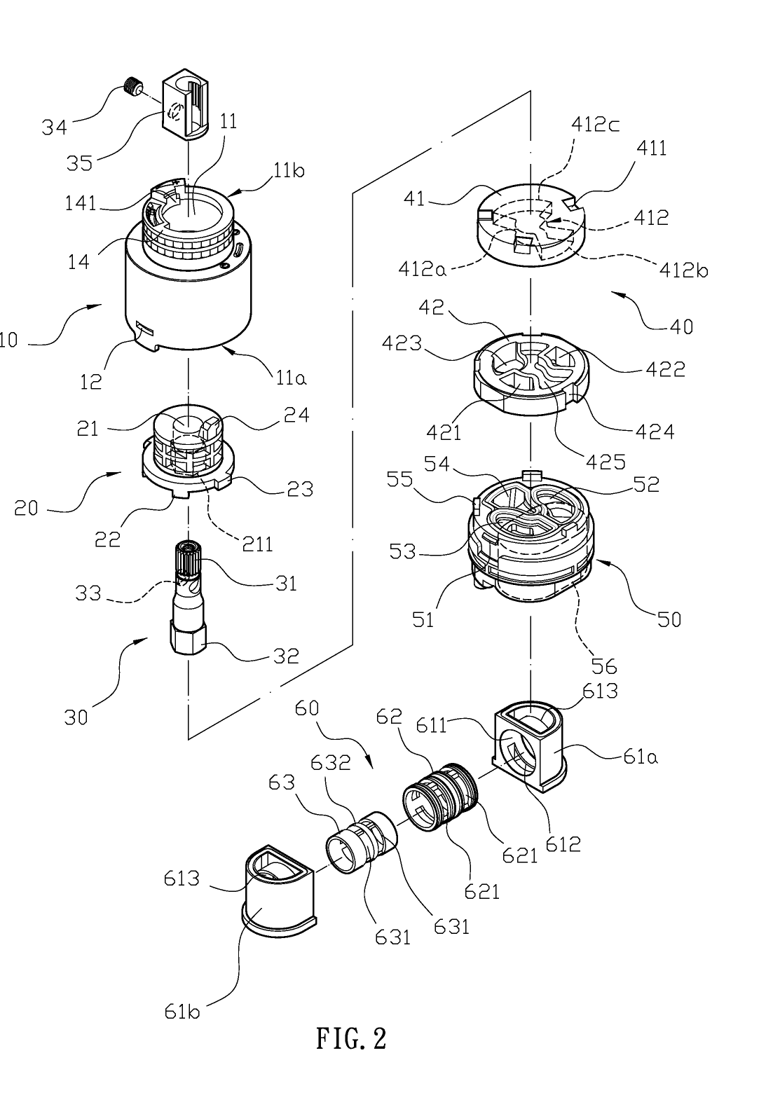

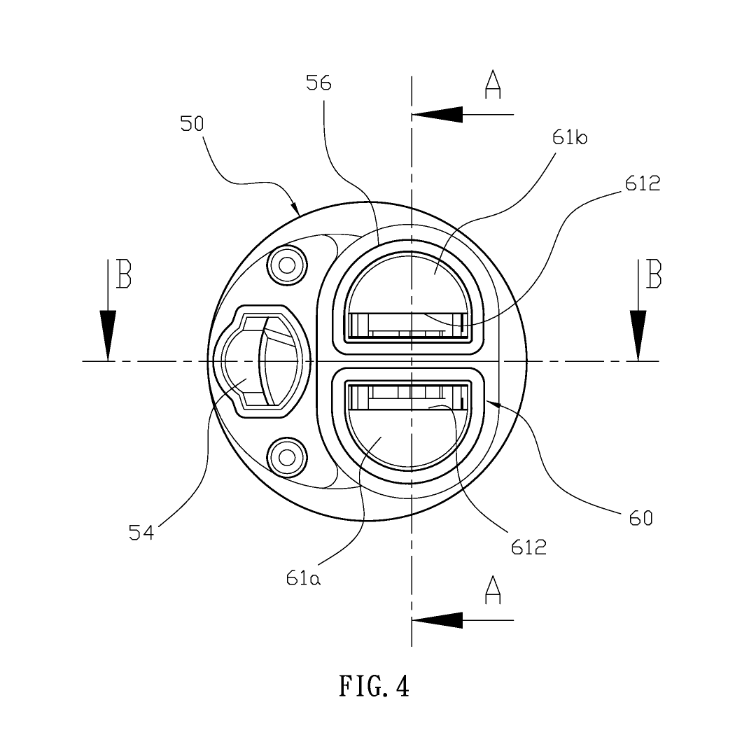

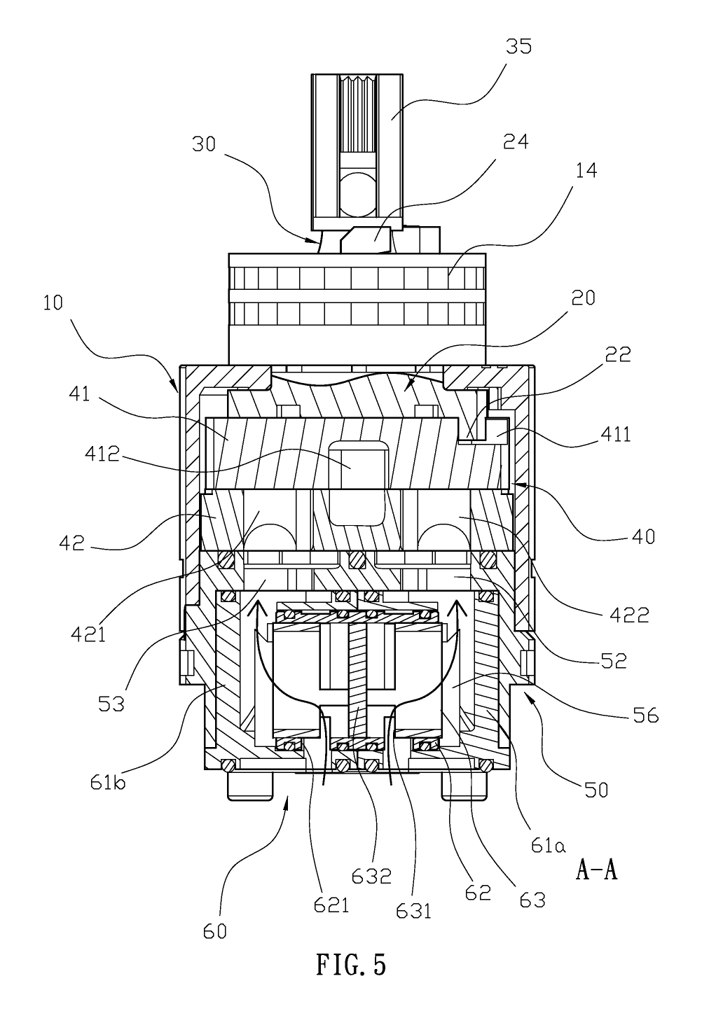

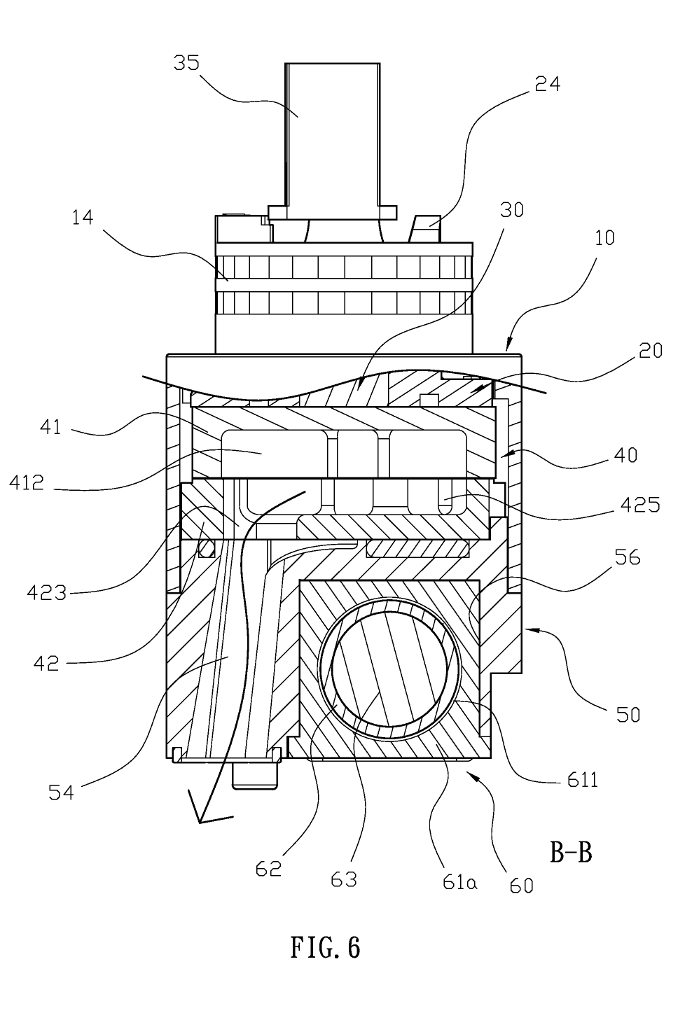

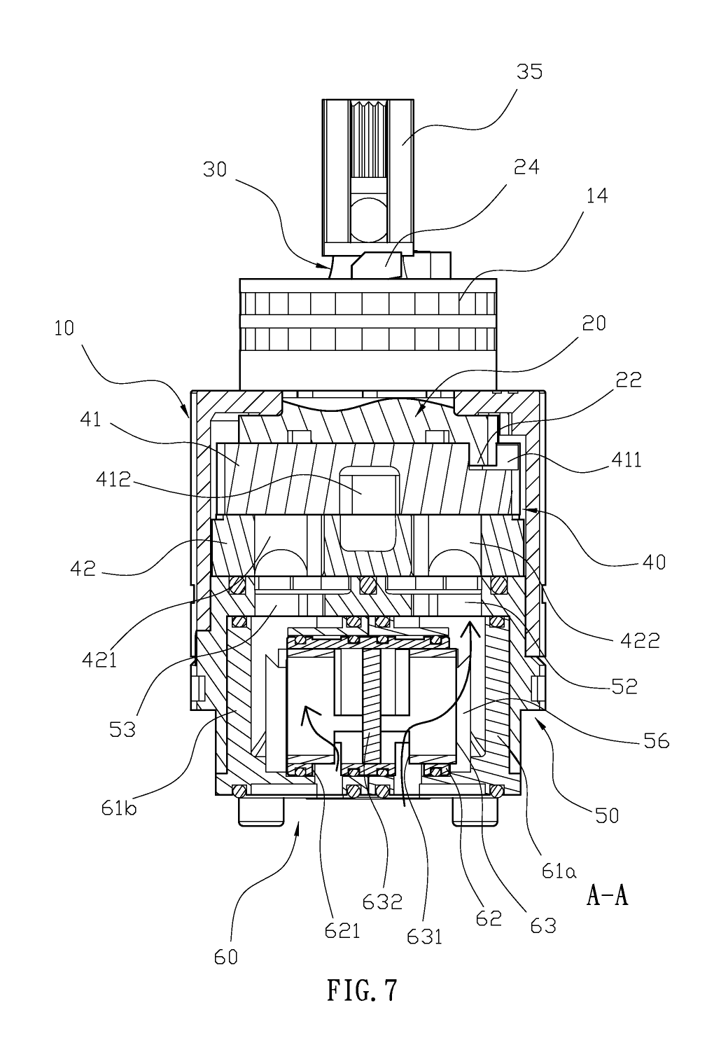

Referring to FIGS. 2, 4, 5 and 6 for practical use in the present invention, when the hot and cold water pressure is balanced, the moving valve (63) of the balancing valve set (60) is located at the center of the valve cover (62), so that the flow restricting openings (631) of the moving valve (63) block the same amount of water from the water-guiding slots (621). Meanwhile, the cold and hot water flows through the water-guiding slots (621) and the flow restricting openings (631) from the inlet end (612) of the engaging shells (61a)(61b), and flows into the cold water hole (52) and hot water hole (53) of the valve base (50) from the outlet end (613) of the balancing valve set (60). Also, when the rotating portion (31) of the rotating shaft (30) rotates, the rotating shaft (30) drives the engaging section (211) of the connecting cover (20) through the engaging portion (32), and the connecting block (22) of the connecting cover (20) further pushes the recessed slots (411) of the first valve piece (41) of the ceramic valve set (40) to rotate the second valve piece (42) corresponding to the first valve piece (41). In other words, the cold and hot water respectively passes through the hot water inlet (421) and cold water inlet (422) of the second valve piece (42) and mixes to flow to the collecting trough (412) of the first valve piece (41) through the valve selection of the ceramic valve set (40). Finally, the water outlet (423) of the second valve piece (42) and the water outlet hole (54) of the valve base (50) form the water output. Referring to FIG. 7, when the water is used and divided for different branches, the imbalance of the cold and hot water pressure results. At this time, the moving valve (63) of the balancing valve set (60) is slidingly disposed in the valve cover (62) to push the stopping wall (632) of the moving valve (63) by the cold and hot water pressure, and the moving valve (63) slightly slides towards the end with smaller water pressure. So, the flow restricting openings (631) of the moving valve (63) block different amount of water from the water-guiding slots (621) to adjust the amount of water from therefrom to achieve the goal of automatically adjusting the flow of the cold and hot water by the change of water pressure. It can further achieve the goal of maintaining water output temperature to increase the safety when in use.

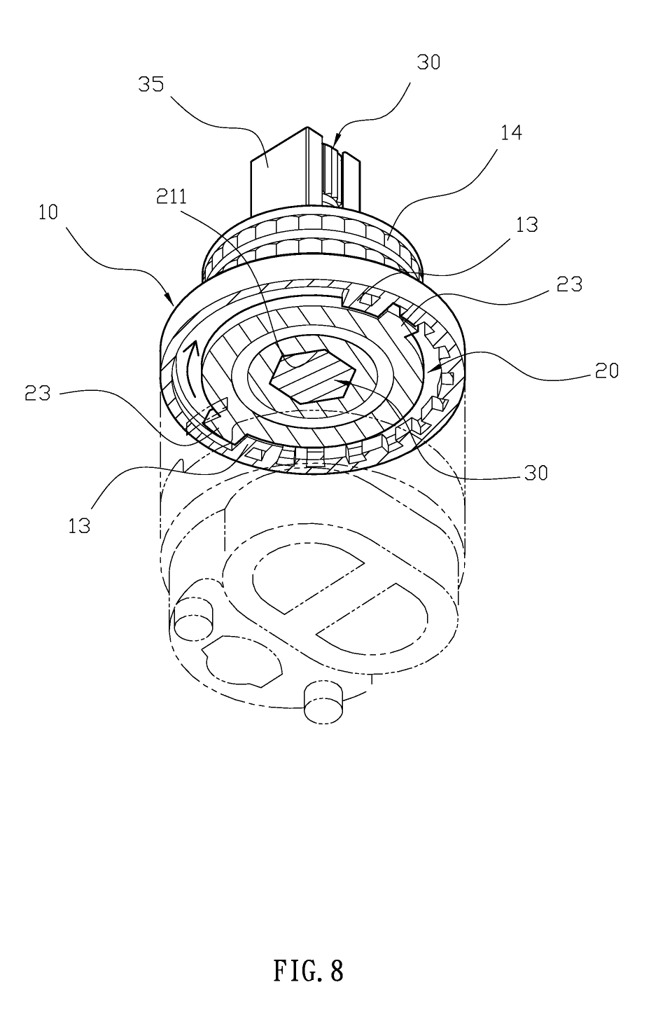

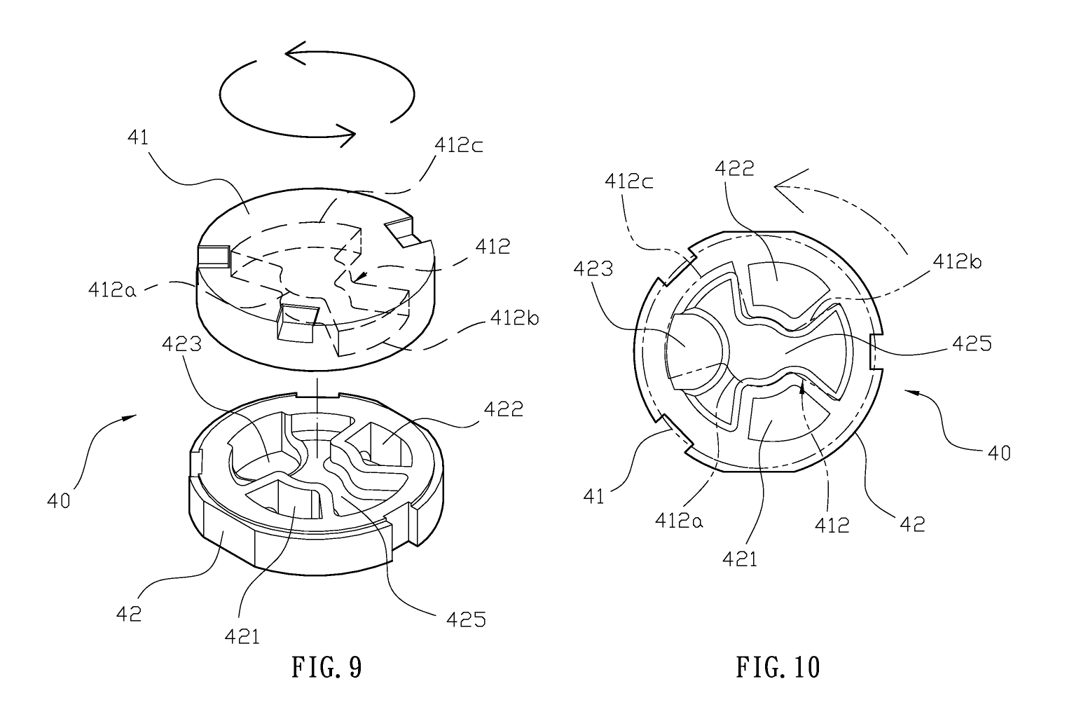

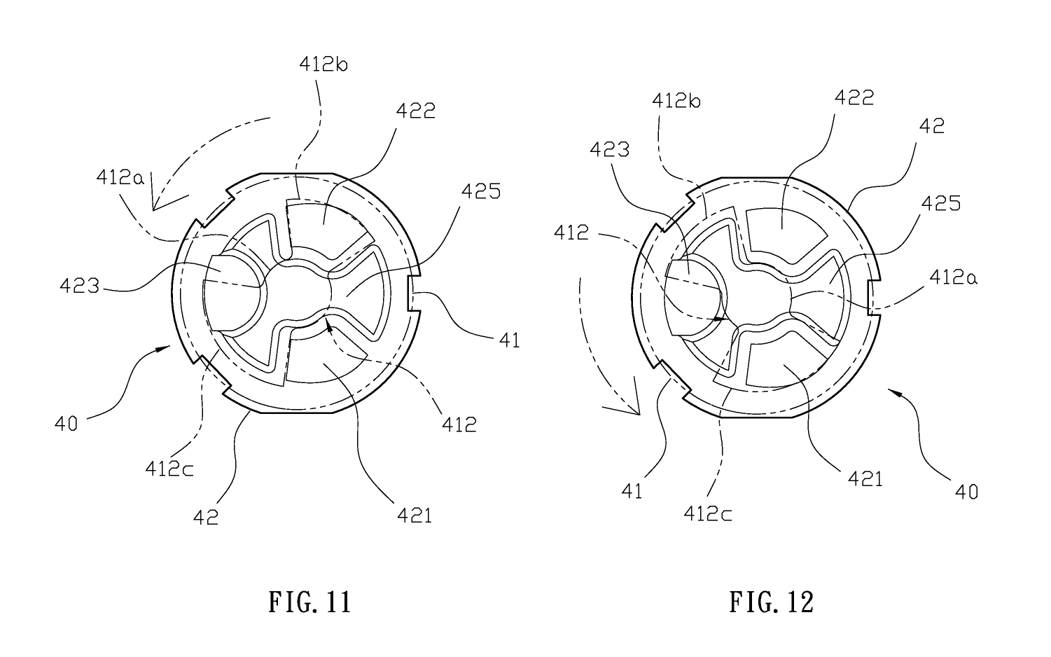

Referring to FIGS. 2 and 8 to 12 for another embodiment, at least one restricting portion (13) is protrudingly formed inside the top end (11b) of the valve shell (10), and an extending portion (23) is protrudingly formed at an outer surface of the engaging section (211) of the connecting cover (20). When the connecting cover (20) rotates axially, the extending portion (23) is blocked and restricted by the restricting portion (13) of the valve shell (10) to control a rotating angle of the connecting cover (20). Furthermore, the rotating angle of the connecting cover (20) is restricted by the valve shell (10), so that the first valve piece (41) driven by the connecting block (22) of the connecting cover (20) can only rotate in angle smaller than 360 degrees. Also, the collecting trough (412) of the first vale piece (41) has a circular portion (412a) that extends to form a first fan-shaped portion (412b) and a second fan-shaped portion (412c), and the area of the first fan-shaped portion (412b) is smaller than the second fan-shaped portion (412c). Moreover, the hot water inlet (421), cold water inlet (422) and water outlet (423) of the second valve piece (42) are disposed as a triangle, and a mixing trough (425) is formed and connected with the water outlet (423) closely attaching to the first valve piece (41), and the mixing trough (425) extends toward a location between the hot water inlet (421) and the cold water inlet (422). When the first fan-shaped portion (412b) and second fan-shaped portion (412c) are aligned with the mixing trough (425), the ceramic valve set (40) shuts off and no water is outputted. When the first valve piece (41) starts to rotate, the first fan-shaped portion (412b) of the collecting trough (412) overlaps the cold water inlet (422) of the second valve piece (42), and if the first valve piece (41) further rotates, the second fan-shaped portion (412c) overlaps the hot water inlet (421) of the second valve piece (42). So, whenever the faucet is in use, the cold water will always come out first and then the warm or hot water to avoid the accident of burning. Furthermore, an adjusting cover (14) is formed at an outer portion of the top end (11b) of the valve shell (10), and a blocking piece (141) is protrudingly formed at an inner edge of the adjusting cover (14). A protruding piece (24) is protrudingly formed at the same direction of the shaft hole (21) of the connecting cover (20), and when the connecting cover (20) rotates axially, the protruding piece (24) is restricted by the blocking piece (141) of the adjusting cover (14) to manually control the water temperature to its maximum.

According to the embodiments discussed above, the present invention has the following advantages: (a) the connecting portion (13) extends from the tube base (11) of the inner tube (10), and the guiding slots (116) are formed at an inner periphery of the tube base (11) of the inner tube (10), the water inner tubes (324) and water outlet tube (325) can be guided through the guiding slots (116) directly to the second path (135) of the connecting portion (13) when passing through the inner tube (10) without restricting the tube body to achieve the goal of tube connection and simplify installation process; and (b) the connecting portion (13) of the inner tube (10) has partition board (131) at the inner periphery, the extension tube (41) of the water outlet head (40) and the water inner tubes (324) to avoid unintentionally pulling of the water inner tubes (324), so that the user can smoothly pull out the extension tube (41) without interfering with the water inner tubes (324) that may be loosened if being pulled.

Having described the invention by the description and illustrations above, it should be understood that these are exemplary of the invention and are not to be considered as limiting. Accordingly, the invention is not to be considered as limited by the foregoing description, but includes any equivalent

What is claimed is:

1. A balancing valve in a faucet, comprising:
a valve shell, having a through receiving space, wherein a bottom end is formed at one end of the receiving space of the valve shell, and a top end is formed at the other end of the receiving space;
a connecting cover, disposed into the receiving space from the bottom end and against the top end of the valve shell, wherein the connecting cover has a through shaft hole that is far away from the top end of the valve shell to form a engaging section, and a plurality of connecting blocks are protrudingly formed at an outer surface of the engaging section of the connecting cover;
a rotating shaft, having a rotating portion and an engaging portion, and disposed at the shaft hole of the connecting cover, wherein the engaging portion is fixed at the engaging section of the connecting cover, and the rotating portion is extending and protruding through the top end of the valve shell;
a ceramic valve set, disposed at the receiving space of the valve shell, and including a first valve piece and a second valve piece, wherein one end of the first valve piece is against the connecting cover, and connects to the connecting blocks to form a plurality of recessed slots, and a collecting trough is formed at a direction from the first valve piece towards the second valve piece, wherein the second valve piece is through to form a hot water inlet, a cold water inlet and a water outlet, and a plurality of notches are recessedly formed at an outer edge of the second valve piece;
a valve base, fixed at the bottom end of the valve shell and against the second valve piece, wherein the valve base forms a cold water hole, a hot water hole and a water outlet hole is at the same position corresponding to the second valve piece, wherein a plurality of restricting blocks are formed at an outer edge of the valve base, and the second valve piece is fixed through the engagement of the restricting block and the notch, and the valve base has a receiving chamber formed between the cold water hole and the hot water hole; and
a balancing valve set disposed in the receiving chamber of the valve base, and having two engaging shells, a valve cover and a moving valve, wherein the engaging shells are symmetric to form a valve-shaft hole for the valve cover, and an inlet end and an outlet end are connected and located at both ends of the valve-shaft hole, and the outlet end of the engaging shells is used to connect the cold water hole or the hot water hole, wherein the valve cover is tubular and two water-guiding slots are formed at the tube wall corresponding to the inlet end of the engaging shells, wherein the moving valve is slidingly formed inside the valve cover, and the moving valve has two flow restricting openings corresponding to the water-guiding slots of the valve cover, and a stopping wall is formed between two flow restricting openings.

2. The balancing valve in a faucet of claim 1, wherein at least one restricting portion is protrudingly formed inside the top end of the valve shell, and an extending portion is protrudingly formed at an outer surface of the engaging section of the connecting cover, wherein when the connecting cover rotates axially, the extending portion is blocked and restricted by the restricting portion of the valve shell to control a rotating angle of the connecting cover.

3. The balancing valve in a faucet of claim 1, wherein the collecting trough of the first vale piece has a circular portion that extends to form a first fan-shaped portion and a second fan-shaped portion, and the area of the first fan-shaped portion is smaller than the second fan-shaped portion, wherein the hot water inlet, cold water inlet and water outlet of the second valve piece are disposed as a triangle, and a mixing trough is formed and connected with the water outlet closely attaching to the first valve piece, wherein the mixing trough extends toward a location between the hot water inlet and the cold water inlet, and when the first fan-shaped portion and second fan-shaped portion are aligned with the mixing trough, the ceramic valve set shuts off and no water is outputted.

4. The balancing valve in a faucet of claim 2, wherein the rotating angle of the connecting cover is restricted by the valve shell, so that the first valve piece driven by the connecting block of the connecting cover is only allowed to rotate in angle smaller than 360 degrees; and when the first valve piece starts to rotate, the first fan-shaped portion of the collecting trough overlaps the cold water inlet of the second valve piece, and if the first valve piece further rotates, the second fan-shaped portion overlaps the hot water inlet of the second valve piece, so that when the faucet is in use, the cold water comes out first and then the warm or hot water to avoid the accident of burning.

5. The balancing valve in a faucet of claim 4, wherein an adjusting cover is formed at an outer portion of the top end of the valve shell, and a blocking piece is protrudingly formed at an inner edge of the adjusting cover, wherein a protruding piece is protrudingly formed at the same direction of the shaft hole of the connecting cover, and when the connecting cover rotates axially, the protruding piece is restricted by the blocking piece of the adjusting cover to manually control the water temperature to its maximum value.

6. The balancing valve in a faucet of claim 1, wherein screw hole is formed at a top portion of the valve shell that the rotating shaft protrudes through, and the screw hole provides a bolt to lock a corresponding unit, so that the rotating shaft is allowed to select a knob that is used for either a circular hole or a square hole through the corresponding unit.

7. The balancing valve in a faucet of claim 1, wherein a plurality of engaging holes are formed at the bottom end of the valve shell, and a plurality of engaging blocks are protrudingly formed corresponding to the engaging holes, and the valve shell and the valve base are connected through the engagement of the engaging holes and the engaging blocks.
